(19) United States
(12) Patent Application Publication
(10) Pub. No.: US 2018/0245966 A1
(43) Pub. Date: Aug. 30, 2018

(54) VEHICLE MASS ESTIMATION

(71) Applicant: JAGUAR LAND ROVER LIMITED, Whitley,Coventry,Warwickshire (GB)

(72) Inventors: Abhi MITTAL, Coventry, Warwickshire (GB); Andrew FAIRGRIEVE, Rugby, Warwickshire (GB)

(21) Appl. No.: 15/553,874

(22) PCT Filed: Feb. 26, 2016
(86) PCT No.: PCT/EP2016/054133

§ 371 Date: Aug. 25, 2017

(30) Foreign Application Priority Data
Feb. 27, 2015 (GB) 1503322.8

(51) Int. Cl. G01G 19/08; G01G 19/12; G01G 21/00; B60C 23/04

(52) U.S. Cl. CPC G01G 19/086; B60C 23/0486; G01G 21/00; G01G 19/12

(57) ABSTRACT

A system for determining the mass of a vehicle includes a mass estimation module for estimating an approximate initial mass value for the vehicle and a force estimation module configured to determine a force value indicative of the force output from the vehicle powertrain. A mass determination module includes a recursive least squares module configured to perform in real-time a recursive least squares calculation based on the approximate initial mass value, the force value, and an acceleration value for the vehicle so as to provide a determination of vehicle mass. The mass determination module is further configured to receive a signal indicative of a user behavior event which indicates a change in the mass of the vehicle, and the mass determination module is configured to determine, in response to the user behavior event, a new approximate initial mass value for a subsequent recursive least squares calculation.

### FIELD OF THE INVENTION

The present invention relates to a system for determining the mass of a vehicle. Aspects of the invention also relate to a method of determining the mass of a vehicle, to a vehicle provided with such a system, to a computer program product and to a non-transitory computer-readable medium.

### BACKGROUND OF THE INVENTION

Many systems in a vehicle would benefit from knowing an estimate of vehicle mass and the determination of vehicle mass is particularly important where systems rely on this calculation for automatic control purposes. For example, in larger vehicles, such as in articulated lorries, vehicle mass can be a selection criteria for gear changing control in a vehicle transmission system having staged gears. Vehicle mass may also be used in the control of anti-lock braking systems or in vehicle fleet management systems where a pool of vehicles share measurement data between themselves. Cruise control systems and intelligent on-board systems, which are becoming increasingly important with the production of more sophisticated vehicles, may also benefit from having an accurate determination of the mass of the vehicle. In light duty vehicles, accurate knowledge of vehicle mass can also be useful in range prediction systems and for central tire inflation systems.

Existing systems are commonly based on Newton's second law of motion, Force=Mass×Acceleration. For example, the force is related to engine torque, which propels the vehicle. If engine torque is known, together with acceleration, the vehicle mass can be calculated. A system may typically repeat the calculation several times to improve the accuracy of the determination.

In one known system, a recursive least squares (RLS) method is used to estimate vehicle mass. The recursive least squares method is a well known mathematical technique which recursively minimizes a weighted least squares linear function relating to its input signals. By way of example, U.S. Pat. No. 6,167,357 describes an RLS method for determining vehicle mass in which Newton's second law is integrated to express vehicle mass in terms of vehicle push force and vehicle speed. This expression is then used in a recursive analysis of the data to determine an estimated vehicle mass.

While this method has advantages, it is a computationally expensive process, and still does not determine the vehicle mass with sufficient accuracy and as quickly as is necessary for all control functions. Furthermore, the method aims to estimate both the vehicle mass and the aerodynamic coefficient, but the optimum conditions for determining these two parameters are not compatible. For aerodynamic drag, which depends on velocity, it is better for the measurements to be made at constant velocity (or at multiple constant velocities), whereas for mass estimation, derived from Force=mass×acceleration, acceleration conditions are preferable.

Against this background, it is an object of the present invention to provide a vehicle mass estimation system and method which offers improved benefit in the determination of vehicle mass compared with known systems.

### SUMMARY

Aspects and embodiments of the invention are set out in the accompanying claims.

According to an aspect of the present invention, there is provided a system for estimating the mass of a vehicle, the vehicle comprising a source of motive power configured to apply a force output through a vehicle powertrain to the wheels of the vehicle, the system comprising a mass estimation module for estimating an approximate initial mass value for the vehicle; a force estimation module configured to determine a force value indicative of the force output of the vehicle powertrain; and a mass determination module comprising a recursive least squares module configured to perform a recursive least squares calculation in real-time based at least in part on the approximate initial mass value, the force value and an acceleration value for the vehicle so as to provide a determination of vehicle mass, wherein the mass determination module is further configured to receive a signal indicative of a user behavior event which indicates a change in the mass of the vehicle and wherein the mass determination module is configured to determine, in response to the user behavior event, a new approximate initial mass value for a subsequent recursive least squares calculation based on the determination of vehicle mass from the previous recursive least squares calculation and the user behavior event. The recursive least squares calculation is carried out in real-time, for force and acceleration data obtained in time step intervals of typically between 0.01 and 0.1 seconds, so that the estimate of vehicle mass is continually updated throughout a vehicle journey, and with improving accuracy throughout the vehicle journey, until such time as a user behavior event occurs after the vehicle journey (for example once the vehicle has stopped and a passenger exits or enters the vehicle or luggage is removed or added to the vehicle) and the initial mass estimate for the recursive least squares calculation is reset. The signal indicative of a user behavior event and which indicates a change in the mass of the vehicle may be received from a vehicle sensor.

The mass determination module may be configured to determine a new approximate initial mass value, for input to the recursive least squares calculation, in circumstances in which the user behavior event indicates a vehicle mass-changing event.

References to “module” are not intended to limit the invention to embodiments in which there are multiple independent processors carrying out the module processes, and the modular functions may be implemented on any number of one or more processing means.

In one aspect, the invention provides a system for estimating the mass of a vehicle, wherein the mass estimation module comprises an electronic processor having an electrical input and an electronic memory device electrically coupled to the electronic processor and having instructions stored thereon; wherein the estimating of the approximate initial mass value comprises the processor of the mass estimation module being configured to access the memory device and execute the instructions stored thereon; wherein the force estimation module comprises an electronic processor having an electrical input and electronic memory device electrically coupled to the electronic processor and having instructions stored thereon, wherein the determination of the force value comprises the processor of the force estimation module being configured to access the memory device of the force estimation module and execute the instructions stored thereon; and wherein the recursive least squares module comprises an electronic processor having an electrical input and electronic memory device electrically coupled to the electronic processor and having instructions stored thereon, wherein said recursive least squares module performing the recursive least squares calculation comprises the processor of the recursive least squares module being configured to access the memory device of the recursive least squares module and execute the instructions stored thereon to determine the vehicle mass.

The force estimation module may be configured to determine a force at the vehicle wheels as an indication of the force output of the powertrain.

The recursive least squares calculation is typically performed by means of a recursive least squares algorithm loaded onto a processor of the system.

By using a mass-changing user behavior event to re-set the starting initial mass value for the recursive least squares calculation, the accuracy of the estimate of vehicle mass, as determined by the algorithm, is improved.

In one embodiment, the initial mass estimation module is configured to determine the approximate initial mass value based on the number of occupants of the vehicle (e.g. passenger(s) and driver) or passenger occupancy. Alternatively, or in addition, the initial mass estimation module is configured to determine the approximate initial mass value based on an output from one or more seat belt sensors. Alternatively, or in addition, the initial mass estimation module is configured to determine the approximate initial mass value based on an output from one or more airbag occupancy sensors. The initial mass estimation module provides a relatively crude estimate of the vehicle mass which forms a starting point for the recursive least squares calculation.

The user behavior event may, for example, include the opening of a vehicle door indicative of a vehicle passenger entering or exiting the vehicle. The system may include at least one door sensor for indicating the opening and/or closing of a vehicle door, but this sensor need not form a part of the system as manufactured.

Alternatively or in addition, the user behavior may include the opening of a vehicle boot or trunk. The system may include a boot sensor for indicating the opening of the vehicle boot, but this sensor need not form a part of the system as manufactured.

The user behavior event may include the opening of a vehicle fueling port. The system may comprise a fueling port sensor for indicating the opening of the vehicle fueling port, but this sensor need not form a part of the system as manufactured.

The mass determination module may further comprise a fuel mass calculation module configured to determine the mass of fuel in the vehicle based on a fuel level signal from a fuel tank sensor.

The mass determination module may be configured to determine a fuel-independent force value based at least in part on the fuel mass and the force value.

The recursive least squares module may be configured to receive the fuel-independent force value and to provide the determination of vehicle mass on the basis of the fuel-independent force value, the acceleration value and the approximate initial mass value. This provides the advantage that throughout a journey for which the RLS calculation is performed, the variable component of force due to the changing fuel level in the vehicle is discounted before the force and acceleration values are input to the RLS calculation (i.e. it can be assumed that the vehicle mass remains constant throughout the vehicle journey).

The system may comprise comprising a threshold comparison module configured to compare at least one vehicle parameter relating to the motion of the vehicle with one or more predetermined condition and to disregard the force and acceleration values from the recursive least squares calculation if the one or more predetermined condition is not satisfied. Such vehicle motion parameters relating to the motion of the vehicle may comprise speed, gear selection, braking force etc.

The use of the threshold module provides the advantage that only values recorded during stable conditions may be provided to the RLS module for input to the RLS algorithm. This serves to reduce spurious results, and improves the accuracy of the mass estimate which is output from the RLS algorithm.

The one or more predetermined condition may include an expected vehicle mass range. The expected vehicle mass range may be varied in response to a measured parameter of the vehicle. For example, the threshold comparison module may be configured to receive a tow bar signal indicative of whether or not the vehicle is towing a load, and wherein the threshold comparison module is configured to adjust the expected vehicle mass range to permit a higher expected mass range if it is detected that the vehicle is towing a load.

Alternatively, or in addition, the one or more predetermined condition may include a stable condition of vehicle operation in which vehicle speed exceeds a predetermined threshold speed, typically about 10 km per hour.

Alternatively or in addition, the one or more predetermined condition includes a minimum time period since a gearshift event, typically a few seconds.

Alternatively, or in addition, the one or more predetermined condition includes a minimum time period since the vehicle was at rest.

The mass determination module may be configured to apply a weighting factor to at least one of the force value, the acceleration value and the approximate initial mass value, as part of the RLS calculation, whereby more recent values have a higher weighting factor than less recent values. This further improves the accuracy of the determination of vehicle mass as more recent values are given preferential weighting in the RLS calculation.

According to another aspect of the invention, there is provide a tire pressure monitoring system for a vehicle including the vehicle mass estimation system of the previous aspect of the invention, and further including means for sensing the pressure in at least one tire of the vehicle, and means for adjusting the pressure in the at least one tire in response to the estimate of vehicle mass.

Other aspects of the invention relate to a vehicle cruise control system or speed control system, an automatic transmission system and a braking system comprising the vehicle mass estimation system in accordance with the aforementioned aspect of the invention, said systems being configured to control one or more vehicle parameter (e.g. speed, gear selection, braking force) at least in response to the determination of vehicle mass.

According to another aspect of the invention, there is provided a method of determining the mass of a vehicle comprising a source of motive power configured to apply a force output through a vehicle powertrain to the wheels of the vehicle, the method comprising estimating an approximate initial mass value for the vehicle; determining a force value indicative of the force output from the vehicle powertrain; performing a recursive least squares calculation in real-time based on the approximate initial mass value, the force value and an acceleration value for the vehicle so as to provide a determination of vehicle mass; detecting a user behavior event which indicates a change in the mass of the vehicle; and determining in response to the user behavior event a new approximate initial mass value for a subsequent recursive least squares calculation based on the determination of vehicle mass from the previous recursive least squares calculation and the user behavior event.

According to another aspect of the invention, there is provided a non-transitory, computer-readable storage medium storing instructions thereon than when executed by one or more electronic processors causes the one or more electronic processors to carry out the method of the previous aspect of the invention.

According to another aspect of the invention, there is provided a computer program product arranged to implement the method of the aforementioned aspect of the invention.

According to another aspect of the invention, there is provided a vehicle comprising the system of the aforementioned aspect of the invention.

The vehicle may comprise an internal combustion engine as the source of motive power, or an electric battery, or a combination of both an internal combustion engine and a battery (i.e. a hybrid-electric vehicle).

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example with reference to the accompanying drawings, in which:

FIG. 1 is a schematic diagram of a vehicle provided with a vehicle mass estimation system according to an aspect of the present invention;

FIG. 2 is a plan view of the vehicle in FIG. 1, to show various drive train and control system components of the vehicle;

FIG. 3 is a schematic diagram of the vehicle mass estimation system of the vehicle in FIGS. 1 and 2; and

FIG. 4 is a flow diagram to illustrate the steps in the calculation of the vehicle mass using the system in FIG. 3.

### DETAILED DESCRIPTION OF EMBODIMENTS

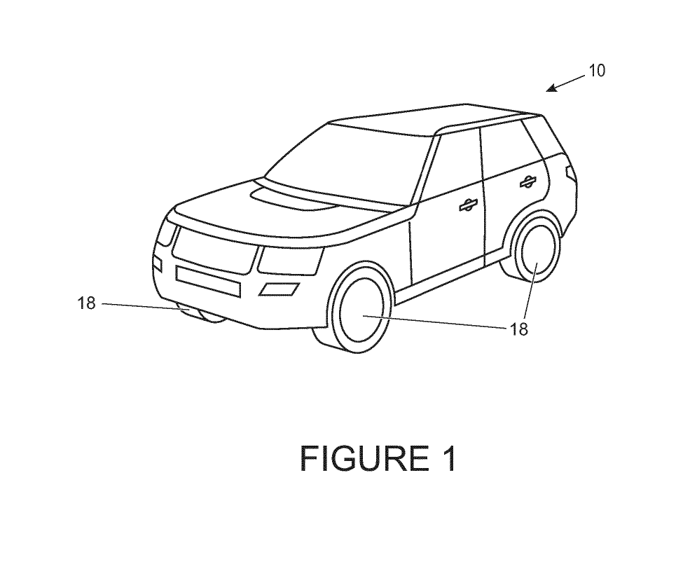

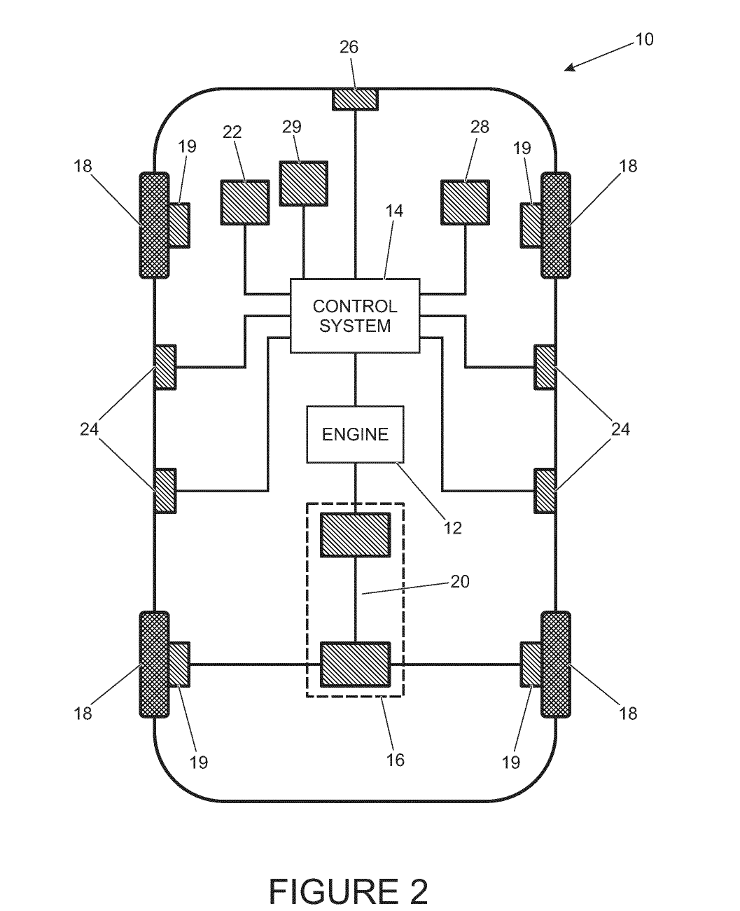

Referring to FIGS. 1 and 2, in a vehicle 10 having a source of motive power in the form of an internal combustion engine 12, a control system 14 is configured to control the fueling of the engine 12 and various other vehicle systems. The engine 12 produces torque, as determined by the fueling level and fueling rate, which is provided to a vehicle powertrain (also referred to as the drive train) to drive the vehicle wheels 18 via a transmission system 16 including gears. The transmission system 16 drives the vehicle wheels 18 via a drive axle 20, and the wheels 18 rotate at a speed which can be measured using a wheel speed sensor 19 mounted on each of the vehicle wheels. Typically, a reference vehicle speed is calculated on the basis of the wheel speed measurements at each of the wheel speed sensors 19, for example by determining an average wheel speed, but other means of determining wheel speed may also be used. The vehicle is also fitted with a brake sensor (not shown) to determine the pressure applied to the vehicle brake pedal.

The vehicle is provided with several other sensors for measuring various other parameters of vehicle and engine operation, including an accelerometer 22 for measuring longitudinal vehicle acceleration. A door sensor 24 is provided on each of the doors to provide an indication of a user behavior event in the form of a door opening event. That is, each door sensor 24 is configured to provide a door opening signal when the associated door is opened. A rear boot or trunk opening sensor 26 is also provided to provide a signal which indicates when the boot or trunk of the vehicle has been opened. A fuel level sensor 28 provides an indication of the fuel level in the vehicle 10. In addition, seat belt sensors 29 (only one of which is shown) provided on each of the seats of the vehicle provide an indication of whether or not the seat belt is engaged, and therefore provide an indication of whether a passenger is occupying the associated seat.

The control system 14 of the vehicle is implemented on an electronic controller of the vehicle, and includes a control module for the engine and various other control elements for controlling other systems and functions on the vehicle. The control module includes electronic data in the form of algorithms and software routines stored on a non-volatile memory component of the vehicle computer. The control module also includes a processor (or multiple processors) which is arranged to execute the electronic data stored on the memory component of the control module to provide various output signals, including an output signal representative of a determination of vehicle mass and various control signals to control operation of the engine and other vehicle systems, such as the braking system, the vehicle cruise control system and the transmission system.

For purposes of this disclosure, it is to be understood that the controller(s) described herein can each comprise a control unit or computational device having one or more electronic processors. Vehicle 10 and/or a system thereof may comprise a single control unit or electronic controller or alternatively different functions of the controller(s) may be embodied in, or hosted in, different control units or controllers. As used herein, the term “control unit” will be understood to include both a single control unit or controller and a plurality of control units or controllers collectively operating to provide the required control functionality. A set of instructions could be provided which, when executed, cause said controller(s) or control unit(s) to implement the control techniques described herein (including the method(s) described below). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present invention is not intended to be limited to any particular arrangement. In any event, the set of instructions described above may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM ad EEPROM); flash memory; or electrical or other types of medium for storing such information/instructions.

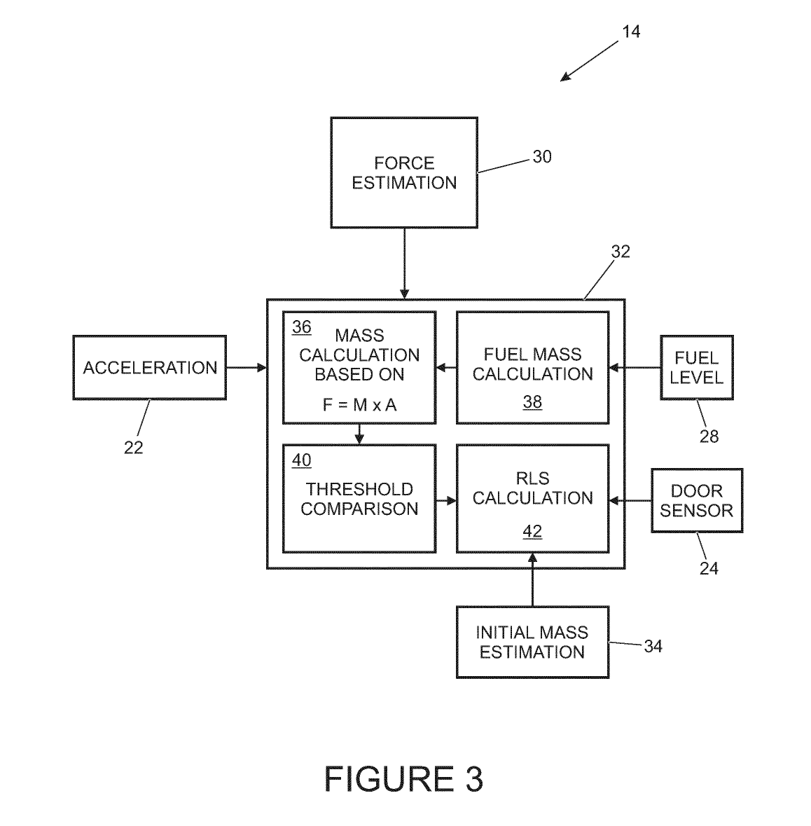

One implementation of the control system for the vehicle is shown in FIG. 3.

The control system 14 uses a recursive least squares algorithm which receives estimated values of vehicle mass throughout a vehicle journey, based on continued force and acceleration measurements which are taken at each time step (typically 0.01 to 0.1 second intervals), to derive a highly accurate determination of the vehicle mass. The determination is carried out ‘real-time’ with the recursive least squares calculation being updated at each time step (i.e. for each new set of force and acceleration values). The calculation is performed throughout the duration of a vehicle journey, with the output estimate of vehicle mass improving in accuracy as more measurements are made and the recursive least squares calculation receives more input data. Changing factors in the vehicle are accounted for, for example changes in the fuel tank reserve and/or changes in the passenger count, and the calculation is ‘re-set’ if such an event is detected when the vehicle journey terminates. Threshold conditions are applied to the measurement data to ensure data collected during conditions which may give rise to spurious calculations of vehicle mass is ignored.

For the purpose of this specification, the phrase ‘real-time’ is intended to mean that the process is carried out in the order of milliseconds or fractions of a second once data has been obtained, and during a vehicle journey, and is not carried out at a substantially later time after data has been gathered (e.g. once the journey has been completed).

The recursive least squares method is a well known mathematical technique which is described in the following papers: Astrom K. J and Wittenmark, B., 1995, Adaptive Control, Addison-Welsey, and “Online Vehicle Mass Estimation Recursive least Squares and Supervisory Data Extraction”, Fathy et al., 2008 American Control conference paper. While the mathematical technique is known when applied to online vehicle mass estimation, the use of it in the illustrated embodiment provides significant benefits in terms of accuracy of performance due to the use of the threshold conditions, and/or the subtraction of the fuel mass from the instantaneous force measurements and/or the use of user behavior events to reset the recursive least squares calculation, as will be described in further detail below.

The control system 14 includes a force estimation module 30 which receives signals from various sensors on the vehicle including the wheel speed sensors and the accelerometer 22, and is configured to calculate the force exerted at the vehicle wheels 18 as a result.

The force estimation module 30 provides a force output signal to a vehicle mass determination module 32. An initial mass estimation module 34 is provided to determine an initial estimate of the vehicle mass which is provided to the mass determination module 32. The mass determination module 32 also receives directly the output signal from the accelerometer 22 which provides an indication of longitudinal vehicle acceleration.

The mass determination module 32 has four key sub-modules: (i) a first sub-module (the mass calculation module 36) which determines an estimate of the mass on the basis of the estimated force signal from the force estimation module 30 in combination with the acceleration signal, and determines the vehicle mass based on said force and acceleration signals; (ii) a second sub-module (fuel mass calculation module 38) configured to calculate the mass of fuel in the vehicle; (iii) a third sub-module (threshold comparison module 40) which determines whether the signals received from the first sub-module 36 and the second sub-module 38 fall within an acceptable threshold range, or above or below certain threshold levels, and (iv) a fourth sub-module (RLS module 42) configured to perform a recursive least squares (RLS) calculation based on the outputs from the first sub-module 36, the second sub-module 38, and the third sub-module 38. The RLS module 42 of the mass determination module 32 receives a relatively crude estimate of the vehicle mass from the initial mass estimation module 34. The RLS module 42 also receives a signal from the door sensors 24 to indicate when one of the doors of the vehicle has been opened.

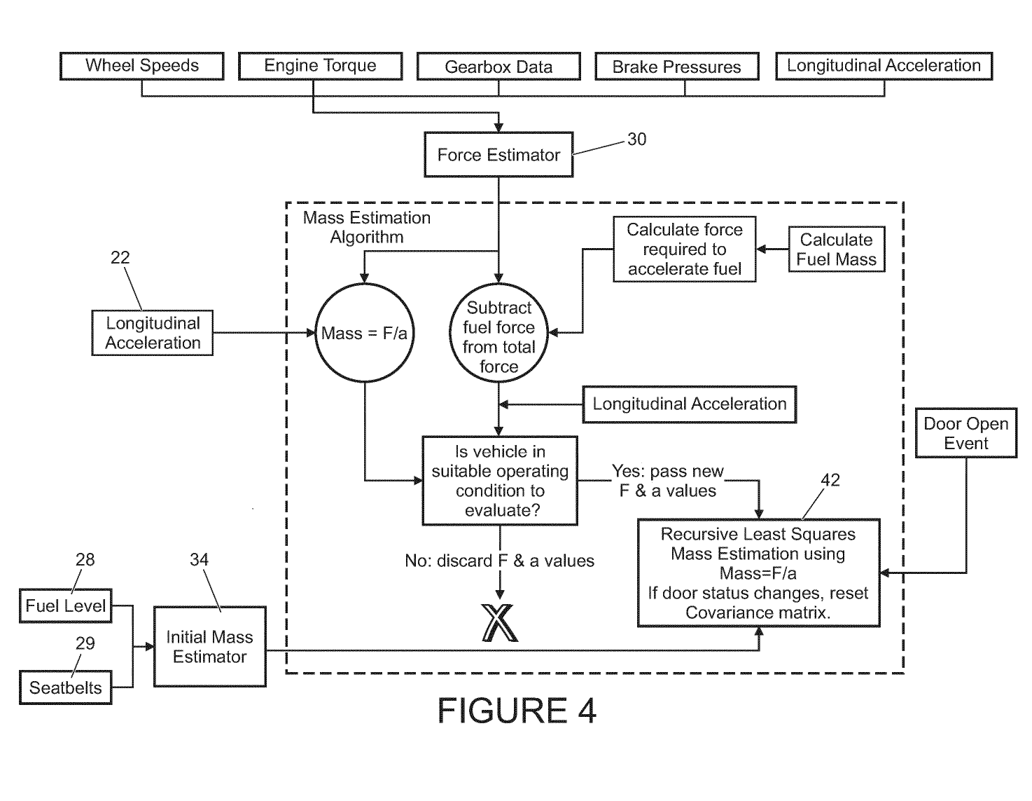

The detail of how the mass determination module 32 operates to determine an accurate value for the vehicle mass will now be described in further detail with reference to FIG. 4 also.

The force estimation module 30 receives data from various vehicle sensors for the purpose of determining a force value indicative of the force output from the vehicle powertrain, being in this example the force which is exerted on the vehicle wheels 18. The data input to the force estimation module 30 includes a signal indicative of the wheel speed 18 provided by the wheel speed sensor, a signal indicative of engine torque as derived from the fueling level and rate, and data from the gearbox, such as a selected gear or the input/output shaft speeds, to enable a determination of the gear ratio. A signal indicative of brake pressure from the brake sensor and a signal indicative of the longitudinal acceleration of the vehicle as derived from the accelerometer 22 are also input to the force estimation module 30. The output from the force estimation module 30 is provided to the mass determination module 32, together with the longitudinal acceleration of the vehicle as determined by the accelerometer 22.

Data is collected over a sequence of time steps, in real-time as the engine is in operation. At an initial time-step, the RLS module 42 receives an input signal from the initial mass estimation module 34, which forms the starting point for the RLS calculation. The initial mass estimation module 34 determines a relatively crude value for the mass of the vehicle based on the known weight of the vehicle when empty (as determined at the point of manufacture), the fuel level signal and an indication of the signal from the seat belts sensors 29 to indicate how many passengers are present in the vehicle.

Typically, for example, if the seat belt sensor associated with the front seat provides an indication that a passenger is present, this would suggest the mass of an adult is present in the vehicle, whereas two passengers in the rear may suggest that two children are in the rear of the vehicle. Typical values for the initial mass estimation include driver mass (70 kg), front seat passenger mass (70 g), rear seat (row 2) passenger mass (50 kg), rear seat (row 3) passenger mass (50 kg), fuel density (0.77 kg/liter), and empty vehicle mass (2400 kg). If the relevant signal is received to indicate a passenger is present the aforementioned values are summed, as appropriate, to provide the initial starting mass value for the RLS algorithm.

The vehicle may, alternatively or in addition, be provided with weight sensors on each of the vehicle seats to provide a more accurate initial mass estimation based on the actual measured mass of the passengers.

An indication that the rear seats are folded down to create a large luggage space may also be used to make a suitable initial mass assumption.

At the next time step, the longitudinal acceleration signal and the output from the force estimation module 30 are provided to the mass calculation module 36 of the mass determination module 32. At each time step, the mass calculation module 36 determines an estimate of the mass of the vehicle based on Newton's second law (Force=mass×acceleration).

The total force, Ft, is represented by:

Ft=(Mv+Mf)×acceleration;

where Mv is the mass of the vehicle and Mf is the mass of the fuel.

The mass calculation module 36 receives a signal from the fuel tank to indicate the level of fuel within the tank and, on the basis of this signal, estimates the mass of the fuel, Mf, in the vehicle. Once Mf is known, the force contribution due to the fuel can be subtracted from the total force calculation to determine the contribution to the force which is independent of the mass of the fuel. This ensures that the variable component of the force due to fuel, which is continually combusted and hence depleted, is removed from the calculation before the fuel-independent force and acceleration values are provided to the RLS module 42. By separating out the fuel mass contribution from the calculation, it can be assumed that the mass of the vehicle remains the same for the entire journey (until, for example, a refueling event is detected, or a user behavior event is detected, which alters the vehicle mass).

The fuel-independent force and acceleration values output from the mass calculation module 36 are input to the RLS module 42 in the form of a tunable covariance matrix. The RLS algorithm stored on the RLS module may be implemented in Simulink and is based on the covariance matrix which effectively determines the extent to which new values for force and acceleration can affect the output calculation of mass from the RLS algorithm. As additional force and acceleration values are fed into the RLS algorithm, the covariance value decreases as confidence in the current estimate increases. At each time step the output from the RLS module 42 is an estimate of the mass at the current time step, and this value is provided back to the RLS routine for the subsequent time step for the next iteration of the RLS calculation. This estimate of the vehicle mass may also be used for other purpose within the vehicle, as will be described in further detail below.

In addition to the singular value for the mass estimate from the mass calculation module 36, the RLS algorithm may be constructed to receive a matrix of values including mass, force, acceleration and other vehicle parameters and to determine other estimations (for example, vehicle rolling resistance and aerodynamic drag). However, the optimum conditions in which to determine aerodynamic drag, for example, do not correspond with the optimum conditions for determining vehicle mass, and so in practice separate RLS calculations may be preferred for these parameters.

Before the mass calculation data is passed to the RLS module 42, the output from the mass calculation module 36 and the force and acceleration values are passed to the threshold comparison module 40 where various checks are made against various threshold conditions for various vehicle parameters to ensure that the current conditions in which the vehicle is travelling are appropriate for the most recent values to be input to the RLS calculation. The threshold conditions may apply to vehicle speed, longitudinal acceleration, gear position, longitudinal power train force, and mass range validity. While the mass determination module 32 is always provided with the current force and acceleration values from the force estimation module 30 and the accelerometer 22 respectively, the covariance matrix and previous mass estimate values are only provided to the RLS module 42 when the conditions are deemed to be suitable i.e. by satisfying the threshold conditions. If the conditions are not suitable the outputs from the RLS module 42 are over written with values from the previous time step at which the threshold conditions were satisfied (or with the initial values if no estimates have yet occurred) and so no RLS calculation is performed for the inappropriate values.

The accuracy of the output from the mass determination module 32 is directly related to the quality of the inputs passed into it. In the case of the RLS algorithm, the ‘memory’ is provided by both the covariance matrix and the previous estimate value for the mass which is output from the RLS algorithm. If these values are prevented from being passed onto the next step (because they do not satisfy one of the threshold conditions), the algorithm behaves as if it has been paused, awaiting the next set of suitable inputs.

Examples of how the threshold conditions may be implemented to improve the accuracy of the output estimate from the RLS algorithm are detailed below.

In a first example, if the vehicle speed is below a lower vehicle speed threshold the force calculation data is ignored. The force calculation algorithm is prone to generating inaccuracies in the fast rate of change of vehicle speed from rest (0 km/h) to around 10 km/h, and so data is ignored for vehicle speeds less than 10 km/h.

In a second example, a threshold condition is applied relating to the power train force. The power train force cannot be estimated if the gear ratio is not stable. Therefore, if there has been a recent gearshift event (within, say, the previous 1 to 2 seconds) the data is ignored. In addition, it has been found that the force must be sufficiently large to produce an acceleration of above 1 m/s² if data is to be accurate, and so the threshold condition is set to ignore data for vehicle acceleration values less than this.

Small accelerations give inaccurate mass values particularly if acceleration is very close to zero, and so if the vehicle acceleration is determined to be below a lower acceleration threshold, the data is ignored. Typically the acceleration threshold may be set to around 1 m/s².

The threshold module 40 is also configured to eliminate mass estimation values which appear spurious because they fall outside of an expected mass range. The threshold mass range is based on the known vehicle mass, as derived from the manufacturer's specification. The threshold mass range may be based on a pre-set value, or may be adjustable in dependence on other conditions in the vehicle. For example, if the vehicle is fitted with a tow sensor (not shown) to indicate that the vehicle is towing a trailer, the threshold condition for mass range is automatically adjusted so as to increase the acceptable mass range in the event that a trailer is being towed.

In practice, for a given journey, it will be appreciated that there will only be a limited number of opportunities for mass estimation to occur when all of the aforementioned threshold conditions are satisfied.

Force calculation data which satisfies the various threshold conditions is passed to the RLS module 42 for input to the recursive least squares (RLS) algorithm.

In one embodiment the RLS module 42 may be configured to apply a weighting factor to each set of values to give exponentially less weight to older values provided to the RLS algorithm. This is referred to as the technique of applying a “forgetting factor” to data whereby as older data is replaced with newer data the older data is weighted with a lesser factor of importance. Alternatively, rather than weighting older data differently, all data may be treated equally but with a confidence value associated with the mass estimate being dependent on the relative age of the input values to the calculation.

The outputs from the RLS module 42 are the mass estimate, which may be used in various vehicle control systems and the covariance matrix for the current time step which is then used for the subsequent RLS calculation for the next time step, as described previously.

The RLS module 42 also receives a signal from the door sensors 24 on the vehicle to provide a reset signal to the RLS algorithm in the event that user activity via one of the vehicle doors is detected. If it is detected that one of the vehicle doors has opened, this may suggest that one of the passengers is exiting the vehicle, so that the mass of the vehicle is noticeably altered. The most recent mass estimate is then adjusted, in accordance with the user event, before the RLS calculation is re-started from the new initial value. By way of example, if it is detected that the front passenger door has been opened and there is a change in the state of the seat belt for the front passenger seat, it is assumed that a passenger of mass 70 kg has exited the vehicle. This mass is then subtracted from the latest estimate of vehicle mass, as derived from the output from the RLS algorithm, and this new reduced mass forms the starting mass value for the subsequent RLS calculation at the next time step.

Other user behavior events which are indicative of a mass change within the vehicle may be used to reset the initial mass value for the RLS algorithm. For example, an output signal from the vehicle boot sensor 26 to indicate that the vehicle boot has been opened may suggest that luggage is being removed from the vehicle. An assumption may be made regarding the typical luggage mass associated with a passenger so that, in the event that it is determined that a passenger has exited the vehicle in combination with a boot opening event, the estimate of vehicle mass is adjusted to compensate for the combined mass of the passenger plus luggage being removed from the vehicle. The adjusted estimate of vehicle mass is then used as a starting value for a new RLS calculation commencing at the next time step.

A determination that the fueling port of the vehicle has been opened may also be used to reset the initial mass estimate provided to the RLS module 42, because this would indicate that the fuel level is about to change significantly and, hence, the current estimate of the vehicle mass will no longer be accurate. In practice, however, the relevance of the fuel contribution to the mass estimate may be accounted for through the use of the fuel-independent force calculation.

As an additional step in the mass estimation method, in a diesel vehicle with a compression ignition engine, an adjustment may be made for the level of AdBlue® which is used for catalytic reduction (SCR) purposes. The AdBlue adjustment is performed in the same way as for the fuel level adjustment and so may be implemented in the fuel mass calculation module 38 in a similar manner so as to adjust the force calculation to remove the component attributable to the AdBlue level, before the mass data is input to the threshold comparison module 40 and the RLS module 42.

A further embodiment of the invention incorporates a tire pressure monitoring system which is arranged to measure the pressure in the vehicle tires and to adjust the tire pressure automatically in response to the estimated vehicle mass. The ideal pressure to which the tires are inflated varies according to the load carried by the vehicle and so adjusting the tire pressure automatically in response to the estimated vehicle mass ensures the tire pressure is always set at an appropriate level for the load carried by the vehicle, and in addition prevents the user from having to measure the tire pressures and make any necessary adjustment themselves.

The present invention extends to electric vehicles and hybrid electric vehicles which include an electric motor to generate the necessary torque for the vehicle wheels. In a hybrid vehicle, the mass estimation system may be similar to that described previously, but with the fuel mass calculation module removed (as there is no fuel carried on-board the vehicle).

It will be appreciated by a person skilled in the art that the invention could be modified to take many alternative forms without departing from the scope of the appended claims.

1. A system for determining the mass of a vehicle, the vehicle comprising a source of motive power configured to apply a force output through a vehicle powertrain to the wheels of the vehicle, the system comprising:
a mass estimation module for estimating an approximate initial mass value for the vehicle;
a force estimation module configured to determine a force value indicative of the force output from the vehicle powertrain; and
a mass determination module comprising a recursive least squares module configured to perform a recursive least squares calculation in real-time based on the approximate initial mass value, the force value and an acceleration value for the vehicle so as to provide a determination of vehicle mass,
wherein the mass determination module is further configured to receive a signal indicative of a user behavior event which indicates a change in the mass of the vehicle and wherein the mass determination module is configured to determine, in response to the user behavior event, a new approximate initial mass value for a subsequent recursive least squares calculation based on the determination of vehicle mass from the previous recursive least squares calculation and the user behavior event, and
wherein the mass estimation module is further configured to determine the approximate initial mass value for the vehicle based on the number of occupants of the vehicle.

2. (canceled)

3. The system as claimed in claim 1, wherein the mass estimation module is configured to determine the approximate initial mass value based on passenger occupancy.

4. The system as claimed in claim 3, wherein the mass estimation module is configured to determine the approximate initial mass value based on an output from one or more seat belt sensors.

5. The system as claimed in claim 1, wherein the user behavior event includes the opening of a vehicle door indicative of a vehicle passenger entering or exiting the vehicle.

6. The system as claimed in claim 5, comprising at least one door sensor for indicating the opening and/or closing of a vehicle door.

7. The system as claimed in claim 1, wherein the user behavior event includes the opening of a vehicle boot or trunk.

8. (canceled)

9. The system as claimed in claim 1, wherein the user behavior event includes the opening of a vehicle fuelling port.

10. (canceled)

11. The system as claimed in claim 1, wherein the mass determination module comprises a fuel mass calculation module configured to determine the mass of fuel in the vehicle based on a fuel level signal from a fuel tank sensor.

12. The system as claimed in claim 11, wherein the mass determination module is configured to determine a fuel-independent force value based at least in part on the fuel mass and the value indicative of the force output from the vehicle powertrain.

13. The system as claimed in claim 12, wherein the recursive least squares module is configured to receive the fuel-independent force value and to provide the determination of vehicle mass on the basis of the fuel-independent force value.

14. The system as claimed in claim 1, comprising a threshold comparison module configured to compare at least one vehicle parameter with one or more predetermined condition and to disregard the force and acceleration values from the recursive least squares calculation if the one or more predetermined condition is not satisfied.

15. The system as claimed in claim 14, wherein the one or more predetermined condition includes at least one of: an expected vehicle mass range, a stable condition of vehicle operation in which vehicle speed exceeds a predetermined threshold speed, a minimum time period since a gearshift event, and a minimum time period since the vehicle was at rest.

16. The system as claimed in claim 15, wherein the threshold comparison module is configured to receive a signal indicative of a vehicle condition, and to adjust the expected vehicle mass range in response to the vehicle condition.

17. (canceled)

18. The system as claimed in claim 15, wherein the predetermined level is about 10 km per hour.

19-20. (canceled)

21. A tire pressure monitoring system including the vehicle mass estimation system of claim 1, including means for sensing the pressure in at least one tire of the vehicle, and means for adjusting the pressure in the at least one tire in response to the estimate of vehicle mass.

22. A method for determining the mass of a vehicle, the vehicle comprising a source of motive power configured to apply a force output through a vehicle powertrain to the wheels of the vehicle, the method comprising:
estimating an approximate initial mass value for the vehicle;
determining a force value indicative of the force output from the vehicle powertrain;
performing a recursive least squares calculation in real-time based on the approximate initial mass value, the force value and an acceleration value for the vehicle so as to provide a determination of vehicle mass;
detecting a user behavior event which indicates a change in the mass of the vehicle; and
determining in response to the user behavior event a new approximate initial mass value for a subsequent recursive least squares calculation based on the determination of vehicle mass from the previous recursive least squares calculation and the user behavior event, and
wherein estimating an approximate initial mass value for the vehicle is based on the number of occupants of the vehicle.

23. The method as claimed in claim 22, comprising comparing at least one vehicle parameter with one or more predetermined condition and disregarding the force and acceleration values from the recursive least squares calculation if the one or more predetermined condition is not satisfied.

24. A non-transitory, computer-readable storage medium storing instructions thereon that when executed by one or more electronic processors causes the one or more electronic processors to carry out the method of claim 22.

25. (canceled)

26. A vehicle comprising the system as claimed in claim 1.

27. The vehicle as claimed in claim 26, wherein the vehicle comprises an internal combustion engine.

28. (canceled)
